(19) United States
(12) Patent Application Publication
(10) Pub. No.: US 2009/0058613 A1
(43) Pub. Date: Mar. 5, 2009

(54) METHOD AND APPARATUS FOR COMMUNICATION BETWEEN READERS HAVING DUAL SENSITIVITY MODES

(75) Inventors: Byounghyun CHUNG, Daejeon-city (KR); Hee Sook MO, Daejeon-city (KR); Nae-Soo KIM, Daejeon-city (KR); Cheol Sig PYO, Daejeon-city (KR)

Correspondence Address: CANTOR COLBURN, LLP, 20 Church Street, 22nd Floor, Hartford, CT, 06103, US

(73) Assignee: Electronics and Telecommunications Research Institute, Daejeon-city (KR)

(21) Appl. No.: 12/059,760

(22) Filed: Mar. 31, 2008

(30) Foreign Application Priority Data
Aug. 29, 2007 (KR) 10-2007-0087273

(51) Int. Cl. H04Q 5/22

(52) U.S. Cl. 340/10.2

(57) ABSTRACT

Provided is a method for communication with between readers having dual sensitivity modes for avoiding conflict between readers arising from interference each other when simultaneously used in a limited space. The method for communication between a tag and a reader using dual sensitivity modes for avoiding conflict between the reader and the tag includes: initializing the reader to a normal sensitivity mode; temporarily selecting a frequency channel by the reader; checking whether or not a different reader uses the selected frequency channel; repeatedly selecting another frequency channel if the other readers occupy the selected frequency channel; switching to a reduced sensitivity mode if the other readers do not occupy the selected frequency channel; and communicating with the tag by the reader in the reduced sensitivity mode.

### CROSS-REFERENCE TO RELATED PATENT APPLICATION

This application claims the priority of Korean Patent Application No. 2007-0087273, filed on Aug. 29, 2007, in the Korean Intellectual Property Office, the disclosure of which is incorporated herein in its entirety by reference.

### BACKGROUND OF THE INVENTION

1. Field of the Invention

The present invention relates to a method and apparatus for communication between a tag and readers using dual sensitivity modes capable of being used in a general reader and a mobile/portable reader so as to minimize interference between readers for avoiding conflicts between RFID readers.

2. Description of the Related Art

Recently, radio frequency identification (RFID) markets and applications have been rapidly widened. A plurality of RFID readers are used at the same time in a limited space such as a storehouse, a shopping mall, and an exhibition hall. In the future, the RFID markets are expected to be more activated. Therefore, a plurality of mobile/portable readers as well as a plurality of general RFID readers will be used at the same time in such a limited space.

In such cases, conflict and interference between the readers are expected to be more serious, so that an RFID reading ratio may be deteriorated. Therefore, a product with an RFID tag attached thereto may not be read by the reader.

As an existing approach for avoiding the conflict between the readers, the readers are separated into a receiving group and a transmitting group. More specifically, the separated receiving and transmitting groups perform reading tags in a synchronization manner.

The approach is available for general readers, that is, fixed type wire-communication readers but not for wireless communication environment. That is because mobile/portable readers are practically not easy to synchronize with neighboring readers. A wireless reader can synchronize with readers at a short distance, so that the wireless communication is available. However, the wireless reader is not easy to synchronize with readers at a long distance due to its signal uncertainty.

FIG. 1 is a view for explaining interference between general readers having only a normal sensitivity mode.

Referring to FIG. 1, interference occurs between readers R1 and R2.

A passive RFID tag with no battery supplied thereto has poor sensitivity. Therefore, the passive RFID tag can be read only at a short distance. On the contrary, the RFID reader has unnecessarily high sensitivity, so that the RFID reader can exert and receive influence at a long distance. Due to such a difference between a reading range 111 or 121 and a sensitivity coverage 113 or 123, neighboring readers outside the reading ranges influence to each other within the sensitivity coverages.

### SUMMARY OF THE INVENTION

A passive RFID tag with no battery supplied thereto has poor sensitivity. Therefore, the passive RFID tag can be read only at a short distance. On the contrary, the RFID reader has unnecessarily high sensitivity, so that the RFID reader can exert and receive influence at a long distance. Due to such a difference between a reading range and a sensitivity coverage, neighboring readers outside the reading ranges influence to each other within the sensitivity coverages. The present invention is contrived to solve such an interference problem.

The present invention provides a method for communication between a tag and a reader using dual sensitivity modes for avoiding conflict between the readers and deterioration in a reading ratio when a plurality of the readers are used in a specific space at the same time.

The present invention also provides a reader apparatus using dual sensitivity modes for reducing interference between readers.

According to an aspect of the present invention, there is provided a method for communication between a tag and a reader using dual sensitivity modes for avoiding conflict between the reader and the tag, comprising: initializing the reader in a normal sensitivity mode; the reader temporarily selecting a frequency channel; checking whether or not a different reader uses the selected frequency channel; if the different reader uses the selected frequency channel, temporarily a different frequency channel; if the different reader does not use the selected frequency channel, switching to a reduced sensitivity mode; and the reader communicating with the tag in the reduced sensitivity mode.

According to another aspect of the present invention, there is provided a reader apparatus using dual sensitivity modes for avoiding conflict between a reader and a tag, comprising: a frequency channel selector which allows the reader to temporarily select a frequency channel; a channel scanner which checks whether or not a different reader uses the selected frequency channel; a sensitivity mode controller which sets the reader to a normal sensitivity mode as an initial mode and switches to a reduced sensitivity mode sensitivity as a result of the checking of the channel scanner if the different reader does not use the selected frequency channel; and a communication unit which allows the reader to communicate with the tag in the reduced sensitivity mode.

### BRIEF DESCRIPTION OF THE DRAWINGS

The above and other features and advantages of the present invention will become more apparent by describing in detail exemplary embodiments thereof with reference to the attached drawings in which:

FIG. 1 is a view for explaining interference between general readers having only a normal sensitivity mode;

FIG. 2 is a view illustrating a sensitivity coverage of a reader using a normal sensitivity mode and a reduced sensitivity mode for avoiding conflict between readers according to an embodiment of the present invention;

FIG. 3 is a view illustrating a reader having a reduced sensitivity mode according to the embodiment of the present invention in comparison with a neighboring reader having only a normal sensitivity mode;

FIG. 4 is a flowchart of a method for communication between a tag and a reader using dual sensitivity modes for avoiding conflict between readers, according to another embodiment of the present invention; and

FIG. 5 is a block diagram illustrating a reader apparatus using dual sensitivity modes for avoiding conflict between readers, according to another embodiment of the present invention.

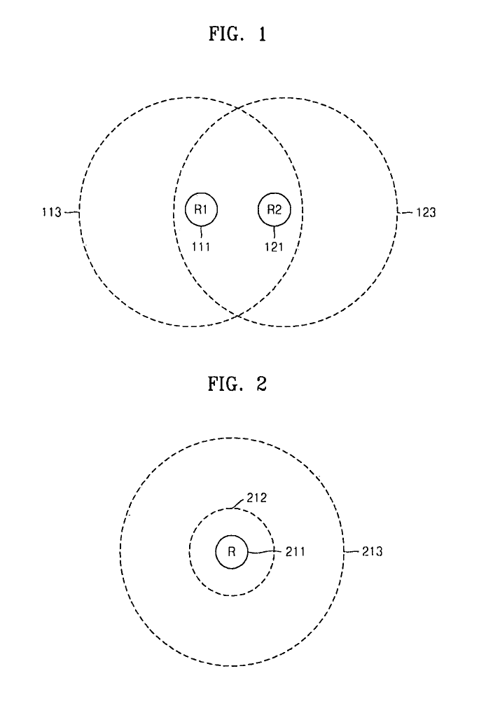

### DETAILED DESCRIPTION OF THE INVENTION

Now, methods and devices according to embodiments of the present invention will be described in detail with reference to the accompanying drawings. In the description of the present invention, well-known techniques or construction may be omitted for clarifying the present invention. Terms in the specification are defined by taking into consideration functions in the present invention, and thus, the terms may be varied according to intentions of clients, operators, or users or according to existing usages. There, it should be noted that the definitions of the terms is to be analyzed based on the whole specification of the present invention.

A passive RFID tag with no battery supplied thereto has poor sensitivity. Therefore, the passive RFID tag can be read only at a short distance. On the contrary, the RFID reader has unnecessarily high sensitivity, so that the RFID reader can exert and receive influence at a long distance. If the sensitivity of the RFID reader is reduced, the influence can be greatly reduced, so that the conflict between the readers can be avoided.

In addition, although it is important for the reader to receive less influence from the neighboring readers, it is very important for the reader not to exert influence on the neighboring readers. In general, the interference coverage in which the output power of the reader exerts influence on the neighboring readers is much wider than a reduced sensitivity coverage. Accordingly, the influence coverage and the reduced sensitivity coverage need to be taken into consideration in order to avoid the conflict between the readers.

That is, if an RFID reader has a reduced sensitivity mode and a normal sensitivity mode in which the RFID reader can sense frequency channel occupation of the neighboring readers in the interference coverage, the RFID reader will not receive, nor will it exert influences.

FIG. 2 is a view illustrating a sensitivity coverage of a reader having a normal sensitivity mode and a reduced sensitivity mode for avoiding conflict between readers according to an embodiment of the present invention.

In FIG. 2, a circle 211 denotes a reading range between a reader and a tag. Since the reading range depends on a sensitivity of a passive RFID tag that is very insensitive in comparison with the reader, the reading range is very small.

In FIG. 2, a circle 212 denotes a reduced sensitivity coverage of the reader. In order to read the tag, the reader transmits a signal and reads a signal returned from the tag. Since an intensity of the signal approaching the tag is weaker than that of the signal returning to the reader, the reduced sensitivity coverage of the reader is wider than the reading range.

In FIG. 2, a circle 213 denotes a normal sensitivity coverage. If all the readers and other IT devices have the same reduced sensitivity in a limited space, that is, a space where influence can be exerted and received, it may not be considered whether or not the readers and devices occupy the associated frequency channel. However, in real environments, signals output from the reader may be the interference signals that interfere with neighboring readers and IT devices having a high sensitivity at a long distance. Therefore the normal sensitivity mode is required so as to check whether or not the associated frequency channel is occupied in the interference coverage.

As described later in detail, it is checked whether or not the associated frequency channel is occupied in the interference coverage, and if the frequency channel is not occupied, the sensitivity mode is switched to the reduced sensitivity mode so as to reduce the interference.

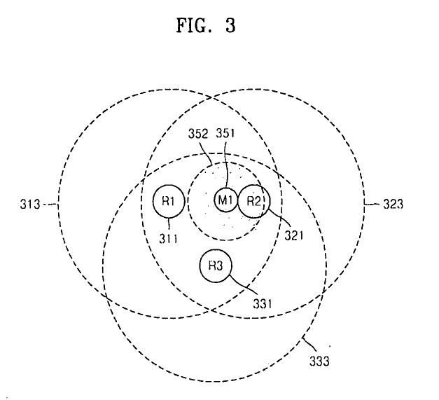

FIG. 3 illustrates a reader having a reduced sensitivity mode according to the embodiment of the present invention in comparison with a neighboring reader having only a normal sensitivity mode.

Referring to FIG. 3, it can be seen that a reader M1 having the reduced sensitivity mode receives less influence than general neighboring readers R1, R2, and R3. In FIG. 3, a solid circle denotes a reading range, and a dotted circle denotes a sensitivity coverage.

The dotted circles, that is, the normal sensitivity coverages of the general readers R1, R2, and R3 are overlapped with each other, so that these readers interfere with each other. However, the dotted circle, that is, the reduced sensitivity coverage of the reader M1 is interfered with only by the general reader R2. In other words, the reader M1 is interfered with by the general reader R2, but not by other general readers R1 and R3. This is because the sensitivity coverage of the reader M1 is relatively smaller than those of the general readers.

Preferably, the reader M1 having the reduced sensitivity mode is a mobile/portable reader.

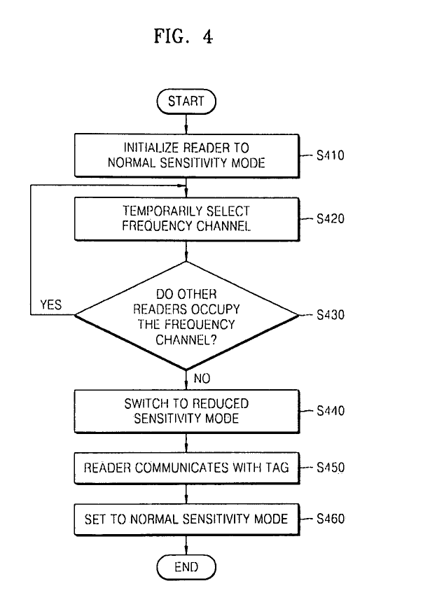

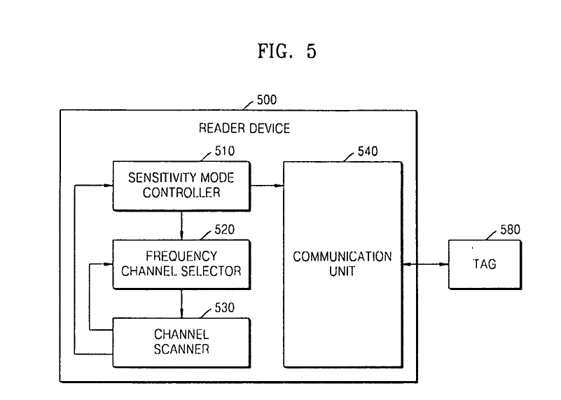

FIG. 4 is a flowchart of a method for communication between a tag and a reader having dual sensitivity modes for avoiding conflict between readers, according to another embodiment of the present invention.

Firstly, a reader having dual sensitivity modes is initialized to a normal sensitivity mode (S410). As described above, this is because it is required to check whether or not the same channel is occupied in the interference coverage.

Next, the reader temporarily selects the frequency channel (S420). The reader checks whether or not the selected frequency channel is used by a different reader (S430). The checking operation is performed through channel scanning. If the frequency channel is used by the different reader, operation S420 is repeatedly performed to temporarily select a different frequency channel.

These operations are repeatedly performed until it is determined that the frequency channel is not used by different readers. If the frequency channel selected by the reader is determined not being used by different readers, the sensitivity mode is switched to the reduced sensitivity mode so as to reduce the interference (S440).

Now, in the reduced sensitivity mode, the reader communicates with the tag (S450).

The aforementioned reader is more preferred in a case where a mobile/portable reader is not easy to synchronize with neighboring readers.

Alternatively, when the communication between the reader and the tag is ended up, the sensitivity mode may be initialized to the normal sensitivity mode (S460).

According to the above-described method, the reader device repeatedly performs the normal sensitivity mode and the reduced sensitivity mode as needed, so that the conflict between readers can be effectively reduced.

FIG. 5 is a block diagram illustrating a reader device having dual sensitivity modes for avoiding conflict between readers, according to another embodiment of the present invention.

The reader device 500 includes a sensitivity mode controller 510, a frequency channel selector 520, a channel scanner 530, and a communication unit 540.

The sensitivity mode controller 510 initializes the reader apparatus 500 to the normal sensitivity mode.

In order to reduce interference with different readers, the reader device 500 uses the frequency channel selector 520 to temporarily select a frequency channel.

The channel scanner 530 checks whether or not the selected frequency channel is used by another reader devices. As a result of the checking of the channel scanner 530, if the frequency channel is used (occupied) by another readers, the reader device allows the frequency channel selector 520 to select a different frequency channel.

With respect to the selected frequency channel, the aforementioned operations are repeatedly performed. That is, the channel scanner 530 determines whether or not the selected frequency channel is used by different readers. The operation is repeatedly performed until the frequency channel is not used (unoccupied) by different readers.

As a result of the checking of the channel scanner 530, if the selected frequency channel is determined not being used, the channel scanner 520 transfers a command to the sensitivity mode controller 510 to switch the sensitivity mode to the reduced sensitivity mode.

The sensitivity mode controller 510 sets the reader device 500 to the reduced sensitivity mode, and the communication unit 540 initiates communication with an external tag based on the switching command of the sensitivity mode controller 510.

In this manner, the reader device having the dual sensitivity modes according to the present invention selectively uses the reduced sensitivity mode for reducing the interference, so that it is possible to prevent deterioration in a reading ratio of the reader device and to minimize the interference with different reader devices so as to communicate with the external tag 580.

Preferably, the reader device is a mobile/portable device which is not easy to synchronize in a wireless manner.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for communication between a tag and a reader using dual sensitivity modes for avoiding conflict between the reader and the tag, comprising:
initializing the reader to a normal sensitivity mode;
temporarily selecting a frequency channel by the reader;
checking whether or not other readers occupy the selected frequency channel;
repeatedly selecting another frequency channel if the other readers occupy the selected frequency channel;
switching to a reduced sensitivity mode if the other readers do not occupy the selected frequency channel; and
communicating by the reader with the tag in the reduced sensitivity mode.

2. The method of claim 1, further comprising initializing the reader to the normal sensitivity mode when the communication between the reader and the tag is ended.

3. The method of claim 1, wherein the reader is a mobile or portable device.

4. The method of claim 1, wherein the reader operates irrespective of transmission synchronization or reception synchronization.

5. A reader apparatus having dual sensitivity modes for avoiding conflict among readers, comprising:
a frequency channel selector which allows the reader to temporarily select a frequency channel;
a channel scanner which checks whether or not other readers use the selected frequency channel;
a sensitivity mode controller which sets the reader to a normal sensitivity mode at an initial mode and switches to a reduced sensitivity mode as a result of the checking of the channel scanner if the other readers do not occupy the selected frequency channel; and
a communication unit which allows the reader to communicate with the tag in the reduced sensitivity mode.

6. The reader apparatus of claim 5, wherein the reader apparatus is a mobile or portable reader device.
